(19) United States
(12) Patent Application Publication
(10) Pub. No.: US 2007/0163836 A1
(43) Pub. Date: Jul. 19, 2007

(54) Gutter and edge protection of structures during painting

(76) Inventor: Michael Jurovich, Superior, WI (US)

Correspondence Address: Mark A. Litman & Associates, P.A.;York Business Center, Suite 205, 3209 West 76th St., Edina, MN, 55435, US

(21) Appl. No.: 11/334,518

(22) Filed: Jan. 18, 2006

(51) Int. Cl. E06C 7/42

(52) U.S. Cl. 182/107

(57) ABSTRACT

A solid, relatively elongate cushioning element is provided that is able to be distally guided and positioned relative to a feature on a structure that will be impinged by a ladder. The cushioning element is carried by an upper rung or structural element on the ladder where it can be raised by a painter on the ground and even on the ladder, so that the cushioning element may be properly fixed against the feature. The cushioning element preferably has a shape to it that fits or mates or covers the feature and doesn't merely rest against it. The fit provides greater protection for the feature and greater stability for the ladder. The cushioning element maintains its position by the force of the ladder against it, pressing it against the feature or areas of the structure surrounding the feature.

### BACKGROUND OF THE INVENTION

1. Field of the Invention

The present invention relates to the field of structure treatment, such as window cleaning, stucco repair, and painting, especially exterior painting of structures and the protection of the structure against damage by a ladder during the painting setup and painting process.

2. Background of the Art

When painting structures with significant elevation, it has been necessary to avoid damage being done to the structure by extension ladders or long ladders that lean against the structure. The damage can be done both by the edge of the ladder leaning against features that extend out from the structure (such as the edges of gutters, window sills, tiles, roofing material, soffits and the like) and the ends pf the ladder as they lean against the structure for necessary support. The painter's weight and the weight of the materials carried with the painter.

The typical protection practiced by painters is the placement of cushioning elements on the tips of ladders (e.g., small balls, such as tennis balls) with holes cut in them to cover the metal or plastic tips of the top of the ladder, to ties fabric (such as towels) to the tips of the ladder, or put softer rubber elements on the tips.

It is more difficult to position any form of protection against the edges of the ladders, as the edges do not always contact the surfaces of the structure at the same point along the ladder. Additionally, placing protection along the edges of the ladder may allow the protective element to slide relative to the feature it is attempting to protect, which would destabilize the ladder against the structure.

### SUMMARY OF THE INVENTION

A solid, relatively elongate cushioning element is provided that is able to be distally guided and positioned relative to a feature on a structure that will be impinged by a ladder. The cushioning element is carried by an upper rung or structural element on the ladder where it can be raised by a painter on the ground and even on the ladder, so that the cushioning element may be properly fixed against the feature. The cushioning element preferably has a shape to it that fits or mates or covers the feature and doesn't merely rest against it. The fit provides greater protection for the feature and greater stability for the ladder. The cushioning element maintains its position by the force of the ladder against it, pressing it against the feature or areas of the structure surrounding the feature.

### BRIEF DESCRIPTION OF THE FIGURES

FIG. 1 shows a perspective drawing of one format of cushioning device according to the described technology.

FIG. 2 shows a drawing of the use of one format of cushioning device according to the described technology one a structure.

### DETAILED DESCRIPTION OF THE INVENTION

A solid, relatively elongate cushioning element is provided that is able to be distally guided and positioned relative to a feature on a structure that will be impinged by a ladder. The solid cushioning element may be a foam, elastomer, low density composition, open structure or closed structure, the low density being provided primarily so that it may be easily lifted and carried for application to the intended use. Foam materials would include any polymeric foam, natural or synthetic, such as polyurethane, polystyrene, polyisoprene, polyolefin, and the like. Lightweight constructions and materials preferably may be used, as with balsa wood, foamed metals (with a coating theron to prevent scratching, such as an elastic coating, rubber coating, polymeric coating, paper overlay, and the like.

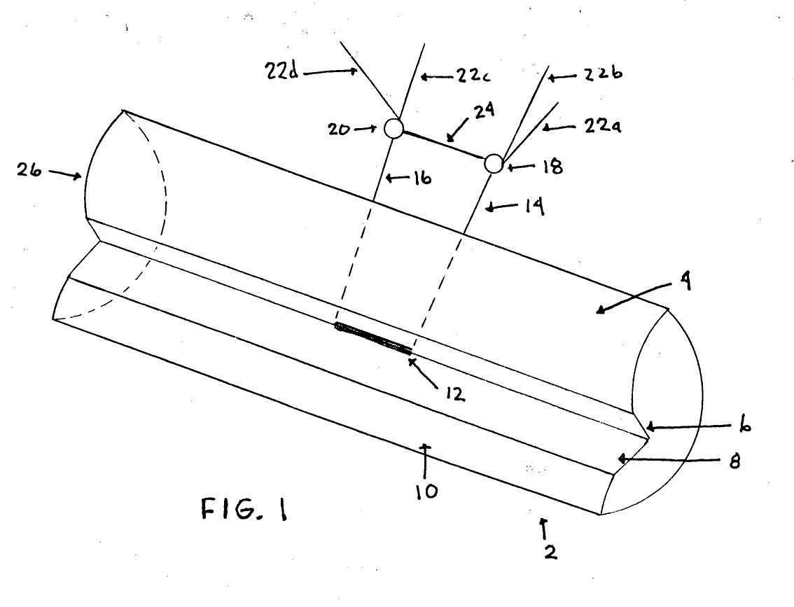

FIG. 1 shows a perspective drawing of one format of cushioning device 2 according to the described technology. The shape of the device 2 is at least elongate, tending towards cylindrical, and the cross-section of the longer dimension may be round, oval square, rectangular, even or uneven at the choice of the manufacturer, although round would tend to be the simplest and most convenient. The body 4 of the device 2 is shown having a uniform groove 6 with a feature grasping face 8 exposed therein. The angle of the groove 6 should be open enough to facilitate entry of the feature (not shown) from the structure (not shown) into the groove 6, which would likely require an angle greater than 20° and smaller than 145°, preferably between 60° and 120°. Approximately central within the length of the groove 6 is shown a bracing element 12 which passes through the body 4 of the device 2. Attached to a rearward end of the bracing device 12 at both ends of the bracing device 12 are shown two attaching elements such as strings, cords, cables or filament 14 and 16 that can be used to stabilize the orientation of he device. The greater the length of the bracing device 12, the greater the tendency towards stability for the device. Given a length of the device between 30 and 120 cm, the length of the bracing device 12 that is affixed to or embedded in the groove 6 may be approximately from 8 to 50 cm in length. It is possible for the two attaching elements 14 and 16 (which will be referred to as strings for simplicity) to be directly fed over the ladder and the two strings 14 and 16 separately manipulated to position the device 2, but alternative designs are improvements over this simplest embodiment. For example, as shown in FIG. 1, each of the strings 14 and 16 are connected to a ring or focusing connector 18 and 20, respectively. There may be a single ring, but two are shown here, with an additional stabilizing bar 24. Additional controlling “strings” 22a 22b 22c and 22d are shown attached to the ring(s) or focusing connector 18 and 20, to assist the painter or worker in positioning the device 2. If there is a single ring 20, for example, each of the two strings 14 and 16 may pass through the single ring, and by pulling on the individual strings 14 and 16 passing over a portion of the ladder, the horizontal orientation of the device 2 may be adjusted. For example, if end 26 of the device is relatively too low for positioning against a feature that is parallel to the ground, string 16 would be pulled or string 14 would be relaxed to adjust the orientation of the device 2. Multiple controlling “strings” 22a 22b 22c and 22d are shown, but single strings may be used. The stabilizing bar 24 may be rigid, semi-rigid, or even flexible, with angular tension between the controlling “strings” 22a 22b 22c and 22d maintaining separation between the rings 18 and 20. A single ring 20 would also work well.

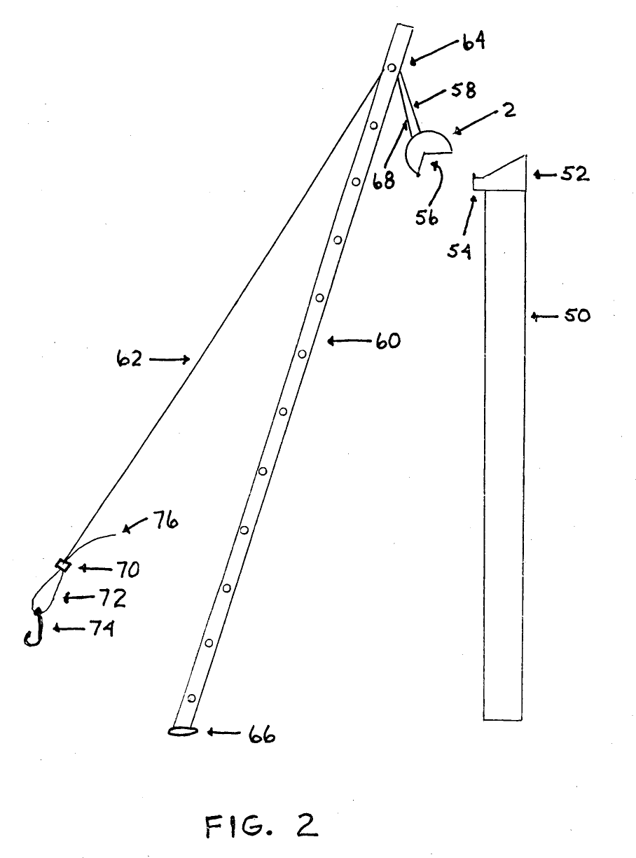

FIG. 2 shows use of one format of cushioning device 2 according to the described technology on a structure 50. The structure 50 is shown with a gutter 52 and the more fragile lip 54 of the gutter 52. The device 2 is shown supported by the two pull strings 58 and 68 and the strings 58 and 68 supported by the rung 64 of the ladder 60. The ladder 60 is shown supported away from the structure 50 to allow for easiest movement of the device 2 although it is possible for the ladder at a very steep (e.g., 85 degrees or more) angle to allow for the device to be pulled up along the wall and push the ladder away from the structure before engaging with the lip 54 of the gutter. It is preferred for a worker to support the ladder 60 away from the structure 50, raise the device 2 to an appropriate level relative to the lip 54 (or other feature) and use the two draw strings 58 and 68 to align the device 2. It is possible to have only a single string replacing the two draw strings 56 and 58, but this would tend to complicate alignment issues, relying on drag forces and friction and luck in engaging the groove 56 with the feature 54. The single or double draw string 62 is pulled to both elevate the device 2 and to assist in orienting the groove 56 horizontally and angularly with respect to the lip 54. When the groove 56 is positioned properly against the lip 54, the ladder is moved towards a resting position against the structure 50 and the draw string(s) 62 manipulated to keep the groove 56 positioned along with the lip 54, usually by slightly drawing on the draw string 62. The draw string 62 is shown with a slide lock, gripping element or locking element 70 that fixes or secures a position of a rung gripping hook 74 that locks onto a rung to assist in fixing the relative position of the cushioning device 2 with respect to the ladder rungs. As the ladder 60 is moved horizontally, the device 2 will remain in a same relative position with regard to the rungs. An extension 76 of the draw string 62 is shown, which is one way of adjusting the position of the hook 74 or other rung gripping element to stabilize the device 2.

A flexible or pivoting footing 66 is also shown on the ladder.

The cushioning element 2 is carried by an upper rung 64 or structural element (e.g., a special hook or glide support may be provided) on the ladder 60 where it can be raised by a painter on the ground and even on the ladder, so that the cushioning element 2 may be properly fixed against the feature 54. The cushioning element 2 preferably has a shape to it that fits or mates or covers the feature 54 and doesn't merely rest against it. The fit provides greater protection for the feature 54 and greater stability for the ladder 60. The cushioning element 2 maintains its position by the force of the ladder 60 against it, pressing it against the feature 54 or areas of the structure surrounding the feature 54.

Other variations within the practice of the present technology will be apparent to those skilled in the art and are within the scope of protection sought herein.

What is claimed:

1. A device for cushioning a ladder against a structure comprising:
an elongated cushioning device having a length and a circumference;
the device having a groove along a forward face of the device;
the device having at least one pull string on a rearward face of the device, opposite the groove.

2. The device of claim 1 wherein there are at least two pull strings on the rearward face of the device.

3. The device of claim 1 wherein a securing element is positioned within the groove and the at least one pull string is attached to the securing element through the device.

4. The device of claim 2 wherein a securing element is positioned within the groove and the pull strings are attached to the securing element through the device.

5. The device of claim 4 wherein pulling on one pull string can raise only a single end of the device to assist in horizontal orientation of the groove.

6. The device of claim 2 wherein the two draw strings pas through a stabilizing element.

7. The device of claim 6 wherein pulling on one pull string can raise only a single end of the device to assist in horizontal orientation of the groove.

8. The device of claim 2 wherein the device comprises a foam material.

9. The device of claim 8 wherein the groove defines an angle of between 60° and 120°.

10. A method of protecting a structure against damages from the mid-arms of a ladder with the device of claim 1, the method comprising passing the at least one draw string over a portion of the ladder at an elevation higher than a feature of the structure that is to be protected, using the at least one draw string to adjust at least a relative height between the feature and the device, engaging the groove of the device with the feature, and allowing the ladder to press the device against the structure.

11. A method of protecting a structure against damages from the mid-arms of a ladder with the device of claim 2, the method comprising passing the two draw strings over a portion of the ladder at an elevation higher than a feature of the structure that is to be protected, using the two draw strings to adjust at least a relative height between the feature and the device, engaging the groove of the device with the feature, and allowing the ladder to press the device against the structure.

12. The method of claim 11 wherein the two draw strings are also use to adjust horizontal orientation of the device with regard to the feature.

13. The method of claim 11 wherein a securing element is positioned within the groove and the pull strings are attached to the securing element through the device.

14. The method of claim 13 wherein pulling on one pull string can raise only a single end of the device to assist in horizontal orientation of the groove.

15. The method of claim 11 wherein the two draw strings pass through a stabilizing element.

16. The method of claim 15 wherein pulling on one pull string can raise only a single end of the device to assist in horizontal orientation of the groove.

17. The method of claim 11 wherein the device comprises a foam material.

18. The device of claim 4 wherein a hook capable of gripping a rung is positioned on an end of the pull string.

19. The device of claim 8 wherein a hook capable of gripping a rung is positioned on an end of the pull string.

20. The device of claim 9 wherein a hook capable of gripping a rung is positioned on an end of the pull string.
